(19) United States
(12) Patent Application Publication
(10) Pub. No.: US 2010/0164258 A1
(43) Pub. Date: Jul. 1, 2010

(54) Ergonomic parachute seat

(76) Inventors: Gary McHugh, Marlton, NJ (US); Girogio Piatti, Williamstown, NJ (US)

Correspondence Address: JACOBSON HOLMAN PLLC, 400 SEVENTH STREET N.W., SUITE 600, WASHINGTON, DC, 20004, US

(21) Appl. No.: 12/318,514

(22) Filed: Dec. 30, 2008

(51) Int. Cl. B64D 17/22; B62J 1/00

(52) U.S. Cl. 297/195.11

(57) ABSTRACT

A parachute seat includes a saddle formed by an ergonomically shaped saddle base member with a cushioning layer thereon that covers and conforms with the shape of the upper surface of the saddle base member. The saddle is preferably received within a sleeve having connecting elements to secure the seat to a parachute harness.

### BACKGROUND OF THE INVENTION

1. Field of the Invention

The present invention is related to the field of manned parachutes and, more particularly, to an ergonomic seat for high altitude parachute jumps.

2. Description of the Related Art

Conventionally, parachute harnesses are provided with straps that pass under the jumper's buttocks or rear upper thighs and serve to support the parachutist while descending under canopy. Such harness straps, however, can lead to discomfort during the jump descent, both from the pressure of the straps and the resulting impairment of blood circulation in the jumper's lower extremities caused by the pressure of the straps on the buttocks and thighs. This problem can be especially acute when parachutists jump from high altitudes, when they may be required to spend an extended period of time in the parachute harness under canopy. Further, when landing in this condition, the jumper is exposed to increased risk of injury due to numbness in the legs from the impaired circulation.

One attempt to overcome the foregoing problems with parachute harnesses, especially when jumping from high altitudes, is the seat is shown in FIG. 1. In the prior art seat, a nylon sleeve is reinforced with a piece of plywood or plastic. However, such a seat can still be very uncomfortable during long descents and can still result in blood circulation impairment and numbness in the legs.

### SUMMARY OF THE INVENTION

In order to overcome the aforesaid drawbacks and ameliorate the physical difficulties experienced by a parachutist when spending extended time in a parachute harness under canopy, the present invention is directed to an improved seat for a parachutist. The seat includes a saddle formed by an ergonomically shaped saddle base member with a cushioning layer thereon that covers and conforms with the shape of at least a substantial portion of the upper surface of the saddle base member. The cushioned saddle is enclosed within a sleeve that has connecting elements to secure the seat to a parachute harness.

In plan view, the upper surface of the saddle is generally rectangular, with the front of the saddle base member, which corresponds to a first longitudinal side, having a protuberance or pommel in the center thereof. On both sides of the pommel, and converging toward the opposite longitudinal side, are two laterally extending leg hollows that provide bearing surfaces for the jumper's lower buttocks and rear upper thighs. The cushioned saddle is received within the sleeve and connected to the parachute harness using the connecting elements.

In use, the jumper is seated facing the pommel with his or her lower buttocks and rear upper thighs respectively positioned in the leg hollows on either side thereof. The curved ergonomic topography of the upper surface of the saddle base member, coupled with the layer of cushioning material provided thereon, provides the jumper with a comfortable and safe base of support that lessens constriction of the jumper's circulation during extended periods of time in the harness under canopy.

Accordingly, it is an object of the present invention to provide a seat for a parachutist that is shaped to conform with the human anatomy for increased comfort.

Another object of the present invention is to provide a cushioned seat for a parachutist that reduces impaired circulation during extended periods of time in the harness under canopy.

A further object of the present invention is to provide an ergonomic seat for a parachutist that can be readily repositioned during deployment, descent and landing so as to be conveniently available to the parachutist without impairing necessary movements or interfering with the rest of the jumper's equipment.

Yet another object of the present invention is to provide an improved parachute seat that is not complex in structure and which can be manufactured at low cost but yet effectively ensures the jumper's full physical readiness for landing.

These together with other objects and advantages which will become subsequently apparent reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1 is a photograph of a prior art seat for use by a parachutist.

FIG. 2 is a photograph of a parachute seat in accordance with the present invention.

FIG. 3A is a photograph showing a front plan view of the cushioned saddle in accordance with the present invention for the parachute seat shown in FIG. 2.

FIG. 3B is a photograph showing a left side perspective view of the saddle shown in FIG. 3A.

FIG. 3C is a photograph showing a front perspective view of the saddle shown in FIG. 3A.

FIG. 3D is a photograph showing another front perspective view of the saddle shown in FIG. 3A.

FIG. 4A is a plan view drawing of the cushioned saddle in accordance with the present invention.

FIG. 4B is a cross-sectional view taken along line A-A of FIG. 4A.

FIG. 4C is a rear view of the saddle shown in FIG. 4A.

FIG. 4D is a side view of the saddle shown in FIG. 4A.

FIG. 4E is a front view of the saddle shown in FIG. 4A.

FIG. 5A is a photograph of a parachutist with the seat of FIG. 2 shown in a plane exit and freefall position.

FIG. 5B is a photograph of the parachutist in FIG. 5A with the seat of FIG. 2 shown in position for canopy descent.

FIG. 5C is a photograph of the parachutist in FIG. 5A with the seat of FIG. 2 shown in position for landing.

FIG. 6 is a plan view drawing of second embodiment of a saddle for the seat in accordance with the present invention.

FIG. 7 is a side view drawing of the saddle shown in

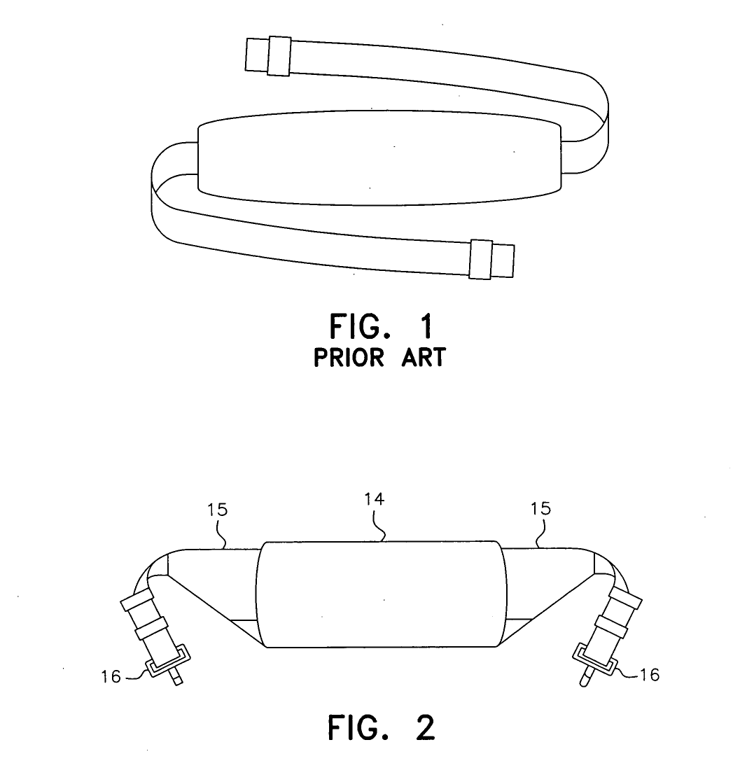

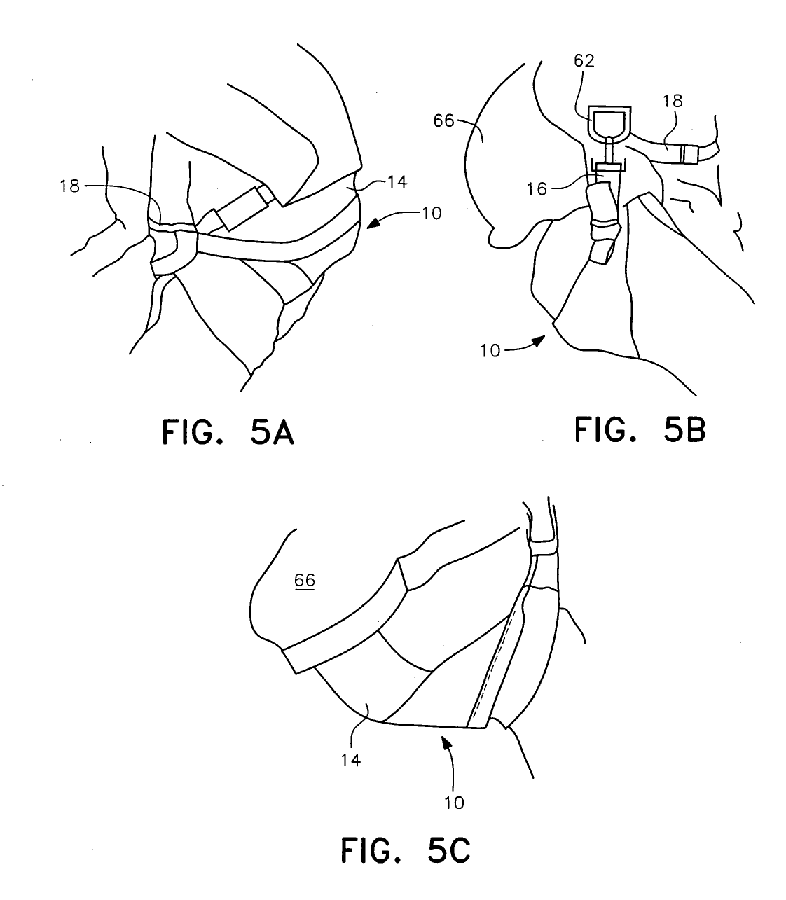

FIG. 6.

### DETAILED DESCRIPTION OF THE PREFERRED EMBODIMENTS

In describing a preferred embodiment of the invention illustrated in the drawings, specific terminology will be resorted to for the sake of clarity. However, the invention is not intended to be limited to the specific terms so selected, and it is to be understood that each specific term includes all technical equivalents which operate in a similar manner to accomplish a similar purpose.

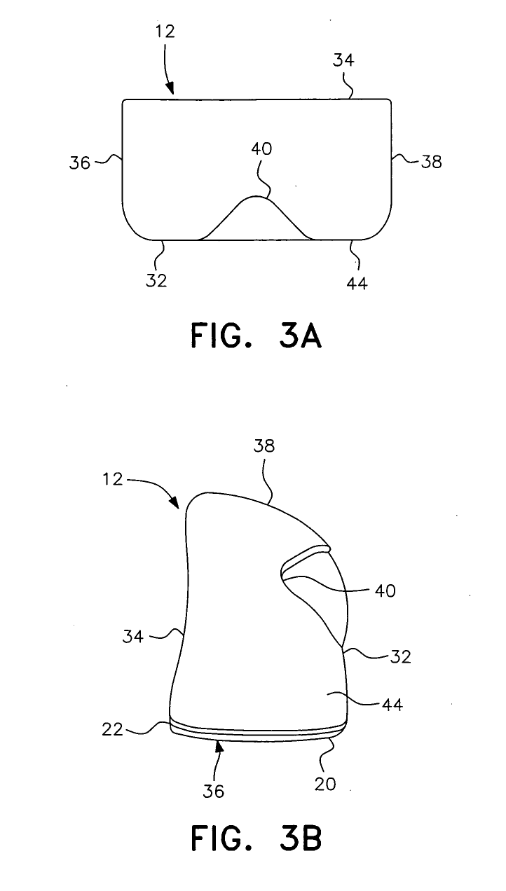

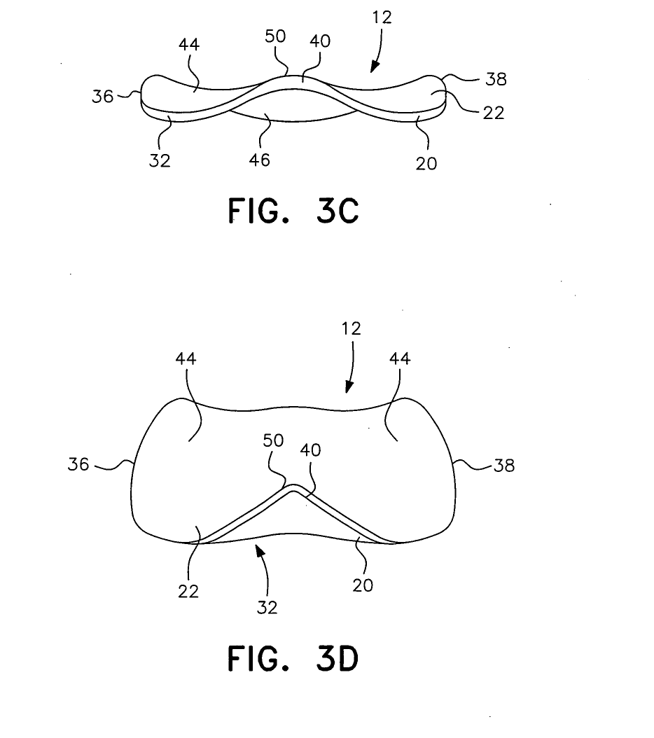

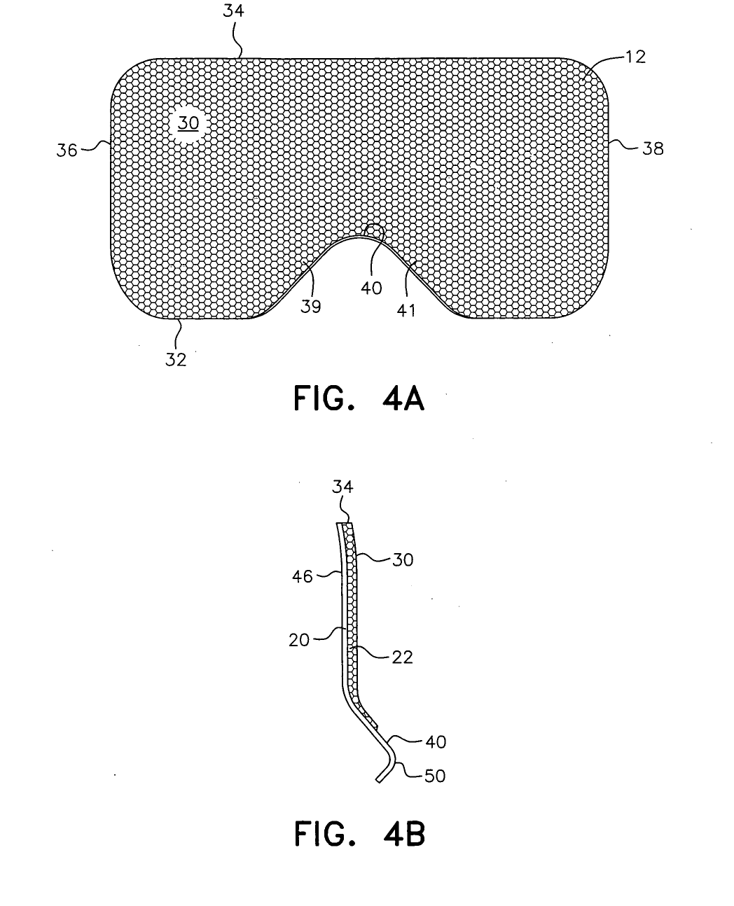

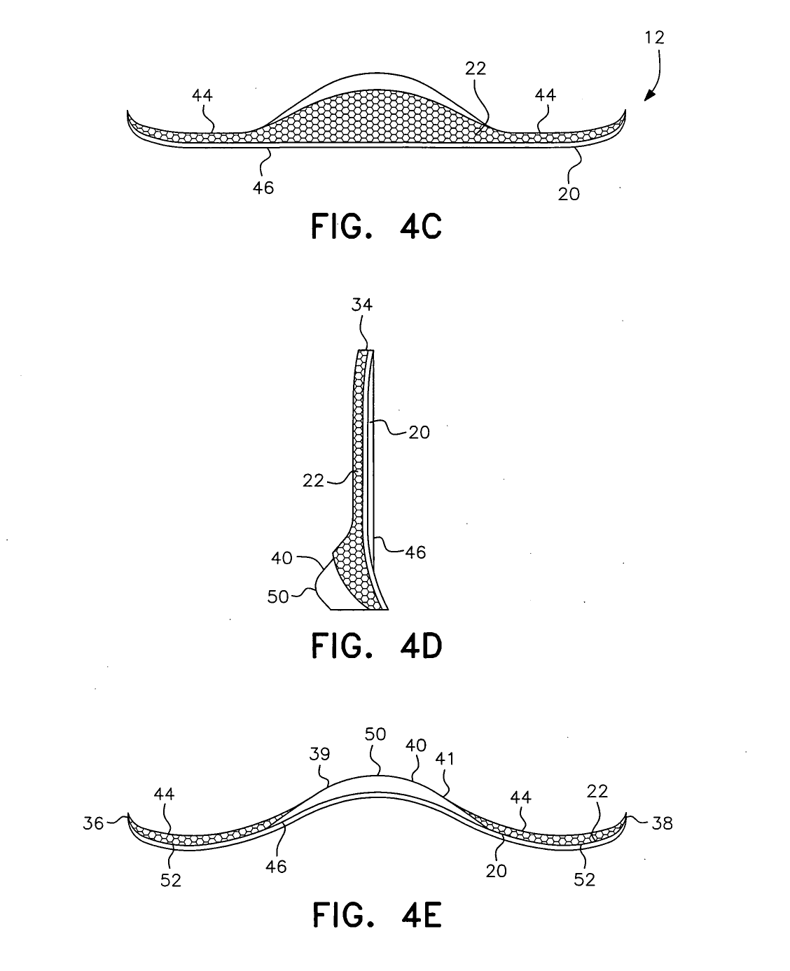

As shown in FIG. 2, the present invention is directed to an improved parachute seat, generally designated by the reference numeral 10. The seat includes a cushioned saddle 12, shown in various views in FIGS. 3A-3D and 4A-4E. The saddle 12 is received within a sleeve 14 that is equipped with connecting elements 16 on either side to secure the seat 10 to a parachute harness 18, as shown in FIGS. 5A-5C.

The saddle 12 includes an ergonomically contoured saddle base member 20 and a cushioning layer 22 that covers and conforms with the shape of the upper surface of the saddle base member 20. The cushioning layer 22 does not have to cover the entire upper surface of the saddle base member 20, but should preferably cover a substantial portion which serves to contact the jumper's lower buttocks and upper rear thighs.

As shown in FIGS. 3A and 4A, in plan view the upper surface 30 of the saddle 12 is generally rectangular, with a front side 32, a rear side 34 and two lateral sides 36, 38. When viewed from the other angles shown in FIGS. 3B-3D and 4B-4E, however, the ergonomic shape of the saddle 12 can be seen. Specifically, the upper surface 30 adjacent the center of the front side 30 has a protuberance or pommel 40. On both lateral sides 39, 41 of the pommel, the upper surface 30 of the saddle 12 slopes first downwardly and then upwardly at a point adjacent the lateral sides 36, 38, to form two laterally extending leg hollows 44 that provide bearing surfaces for the jumper's lower buttocks and rear upper thighs. These leg hollows 44 converge toward the rear side 34, where the jumper's lower buttocks are positioned (see FIG. 5B), to provide a generally V-shaped angle corresponding with a comfortable position for the jumper's legs when seated on the saddle. The benefit of the curvature of the ergonomic shaping is that, for a projected area identical to that of a conventional flat seat, the overall contact area with the jumper's body is increased, thereby reducing local pressure.

The saddle base member 20 is formed as a hard shell of composite material, fiberglass, carbon fiber or other suitable material. Fiberglass is a preferred material as it provides good stiffness yet is easily molded, is light in weight and is reasonable in cost. The hard shell could also be injection molded, although this is less preferred as polymeric materials are generally heavier than fiberglass. However, the present invention is intended to include saddle base members 20 no matter how made, or of any suitable material, provided the material allows the saddle base member to be shaped as disclosed and to provide the necessary structural stiffness.

As can be seen in FIGS. 3C, 3D and 4E, the curvature of the bottom surface 46 of the saddle base member 20 preferably “follows” the curvature of the top surface so that the hard shell does not carry excess material that would add to the weight of the seat.

The cushioning layer 22 that covers the hard shell of the saddle base member 20 is preferably made of closed cell foam as this material is available in various foam densities. Alternatively, a molded gel cushion could be used, such as those used in bicycle seats. Other padding materials could also be used as would be understood by persons of ordinary skill in the art and are intended to fall within the scope of the present invention.

The saddle 12, including the saddle base member 20 and cushioning layer 22, is inserted within a sleeve 14 that is preferably made of a strong nylon material such as conventionally used in parachute applications. The sleeve 14 is preferably provided with a triangular panel 15 on either end, preferably made of the same strong nylon or similar fabric material as the sleeve. These panels enhance the stability of the saddle in terms of preventing front to back rocking motion that might make it difficult for the jumper to initially establish the proper position in the saddle. The panels also provide side support to the jumper's upper thighs and/or hips as shown in FIG. 5B, enhancing the secure and comfortable “fit” of the saddle during canopy descent. Connecting elements 16 are secured to the panels; these elements may extend on the underside across the width of the seat as well for maximum strength.

As can be seen in FIGS. 2, 5B and 5C, it is preferred that the connecting elements 16 be positioned forward of the longitudinal center line of the seat. This positioning gives the jumper the best stability as the upward tension exerted by the straps when the jumper is seated aligns with jumper's center of gravity. The connecting elements may be embodied as adjustable attachment straps 60 with fasteners 61, such as those shown in FIGS. 5A-5C. These straps 60 are attached by the fasteners 61 to the equipment rings 62 on the parachute harness.

FIG. 5A illustrates a preferred placement of the seat 10 as stowed between the back of the parachute harness container and the jumper's body prior to the jumper's exit from the airplane and during the freefall or static phase of descent. Once the main canopy has deployed, the jumper can position the seat under the lower buttocks and rear upper thighs as shown in FIG. 5B to take the pressure off his or her legs during canopy flight. To do this, the jumper while under canopy first loosens the seat straps completely and positions the seat under the buttocks. The seat straps are then tightened alternately until a comfortable position is reached and tension on the leg straps is reduced. This vertical positioning of the seat can be accomplished by the jumper shifting his or her weight to the side of the seat opposite the side being tightened or raised. Finally, during the landing phase of the descent, the seat is moved to the position shown in FIG. 5C which allows the rucksack 66 to be lowered. To reach this last position, the jumper loosens the seat straps, preferably by pulling on a tension release tab which may be provided on the straps to facilitate adjustment.

According to one preferred embodiment, the upper surface 30 of the saddle is about 12-13 inches wide, as measured along the rear side 32 from one lateral side 36 to the other side 38, with a depth from front to back of about 6-7 inches. These dimensions provide the jumper with support and comfort while also keeping the seat quite small, as is necessary to avoid interference with other components of the parachute assembly and harness.

As viewed from the front, see FIG. 4E, the height of the saddle from the top 50 of the pommel 40 to the lowest point 52 on the bottom surface 46 of the saddle base member 20 is preferably less than two inches. The upward curvature of the saddle adjacent each lateral side 36, 38 results in the lateral sides being about one inch higher than the lowest point 52 of the bottom surface 46.

Finally, the pommel is about 6-6.25 inches in width at the front side 32. The sides 39, 41 of the pommel slope both downward and toward one another on the rear side of the pommel top 50 so that the upper surface of the saddle adjacent the center of the rear side 34 is generally flat.

With the dimensions as summarized, the seat can be wedged between the jumper's back and the packed parachute during times of freefall, as shown in FIG. 5A. In addition, the widest dimension of the seat does not exceed the width of the packed main parachute container so that there is no interference between the seat 10 and the rest of the parachute equipment.

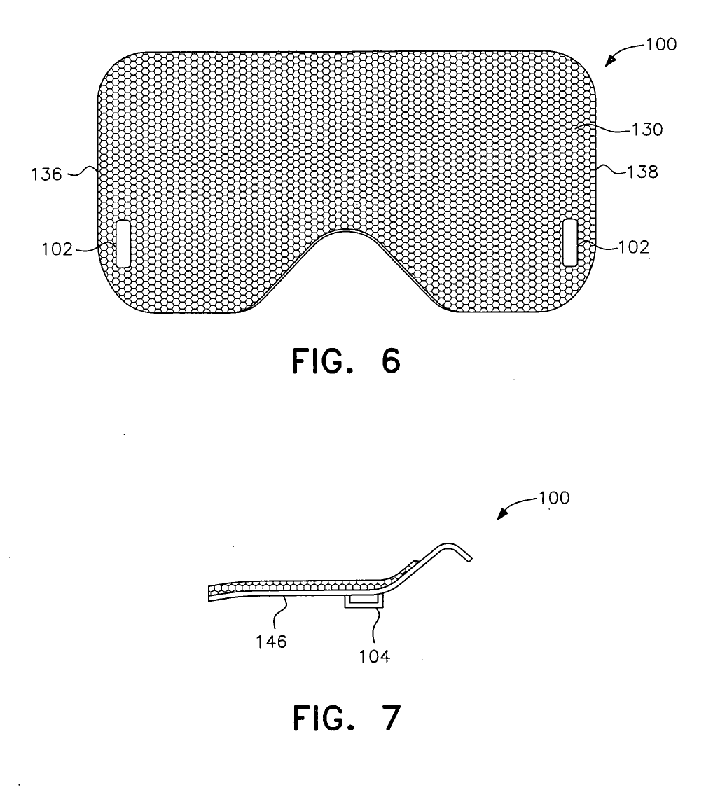

As an alternative embodiment, the seat could include a saddle 100 substantially as described but configured to have the attachment straps fasten directly to the saddle 100 and without a covering sleeve. This connection may be effected by forming slots 102 in the lateral sides 136, 138 of the saddle 100 as shown in FIG. 6, through which the attachment straps (not shown) are passed. A separate strap can be attached to each side, or a single strap can be made to pass through one slot 102, from the top 130 of the saddle to the bottom 146, extend under the seat, and then pass up through the other slot 102. This is a preferable strap arrangement for this second embodiment, as compared with having two separate straps, since the single strap serves to support the bottom 146 of the saddle 100 and also does not exert excess force on the slots 102 themselves. With this arrangement, a channel 104 or spaced loops can optionally be formed on the underside 146 of the saddle 100 as shown in FIG. 7. The strap is passed through this channel 104 (or spaced loops) when extending under the saddle to ensure that the strap remains in the proper position. Alternatively, the strap could be fully incorporated into a slightly thicker composite saddle.

The foregoing descriptions and drawings should be considered as illustrative only of the principles of the invention. The invention may be configured in a variety of shapes and sizes and is not limited by the dimensions of the preferred embodiment. Therefore, it is not desired to limit the invention to the specific examples disclosed or the exact construction and operation shown and described. Rather, all suitable modifications and equivalents may be resorted to, falling within the scope of the invention.

What is claimed is:

1. A parachute seat comprising a saddle having a pommel and two leg hollows on either side of and extending behind the pommel to form an ergonomic upper surface, and connecting elements supporting each side of the saddle for attaching the seat to a parachute harness.

2. The parachute seat as set forth in claim 1, wherein said seat further includes a generally rectangular sleeve into which said saddle is inserted, said sleeve having a fabric panel on each end that is generally triangular in shape, said connecting elements being attached to said panels.

3. The parachute seat as set forth in claim 2, wherein said triangular panels are secured along one of their sides to said sleeve ends to leave a free panel corner, said connecting elements including two attachment straps that are secured to said two free panel corners, respectively.

4. The parachute seat as set forth in claim 3, wherein a leading edge of said panels is generally parallel with a front edge of said sleeve.

5. The parachute seat as set forth in claim 4, wherein said straps extend generally parallel with said panel leading edges.

6. The parachute seat as set forth in claim 5, wherein said straps are closer to said sleeve front edge than to a rear edge of said sleeve.

7. The parachute seat as set forth in claim 1, wherein said saddle includes a saddle base member formed by a hard shell that defines said ergonomic upper surface, and a cushioning layer covering and conforming with at least a substantial portion of said saddle base member upper surface.

8. The parachute seat as set forth in claim 7, wherein said saddle base member is made of a composite material.

9. The parachute seat as set forth in claim 7, wherein said cushioning layer is made of closed cell foam or molded gel.

10. The parachute seat as set forth in claim 7, wherein said seat further includes a generally rectangular sleeve into which said saddle is inserted, said sleeve having a fabric panel on each end that is generally triangular in shape, said connecting elements being attached to said panels.

11. The parachute seat as set forth in claim 10, wherein said triangular panels are secured along one of their sides to said sleeve ends so that a leading edge of said panels is generally parallel with a front edge of said sleeve, said connecting elements including two attachment straps that are respectively secured to free corners of said triangular panels.

12. A parachute seat comprising a saddle that is generally rectangular in plan view so as to have a front longitudinal side, a rear longitudinal side, and two lateral sides, an upper surface of said saddle having an ergonomic shape including a pommel formed in a center of the front longitudinal side and two leg hollows on either side of said pommel, said leg hollows extending toward said rear longitudinal side, each for receiving a thigh area of a parachute seated on said saddle facing said pommel.

13. The parachute seat as set forth in claim 12, wherein said front and rear longitudinal sides are approximately 12-13 inches in length.

14. The parachute seat as set forth in claim 12, wherein said lateral sides are about 6-7 inches in length.

15. The parachute seat as set forth in claim 12, wherein an overall height of said saddle is less than two inches.

16. The parachute seat as set forth in claim 15, wherein said overall height is measured at the pommel.

17. The parachute seat as set forth in claim 12, wherein said saddle includes a saddle base member formed by a hard shell that defines said ergonomic upper surface, and a cushioning layer covering and conforming with said saddle base member upper surface.

18. The parachute seat as set forth in claim 17, wherein said saddle base member is made of a composite material.

19. The parachute seat as set forth in claim 17, wherein said cushioning layer is made of closed cell foam or molded gel.
